(19) United States
(12) Patent Application Publication
(10) Pub. No.: US 2013/0001884 A1
(43) Pub. Date: Jan. 3, 2013

(54) SEALING (PACKING) RING

(76) Inventors: Leonid Borisovich Dobrolyubov, Dnepropetrovsk (UA); Irina Grigorievna Dobrolyubova, Dnepropetrovsk (UA); Anatolyi Ivanovych Stepaniuk, Dnepropetrovsk (UA); Yuryi Anatolyevich Stepaniuk, Dnepropetrovsk (UA)

(21) Appl. No.: 13/511,452

(22) PCT Filed: Dec. 13, 2010
(86) PCT No.: PCT/UA10/00091

§ 371 Date: May 23, 2012

(30) Foreign Application Priority Data
Dec. 25, 2009 (UA) A 2009 13521

(51) Int. Cl. E21B 10/25; F16J 15/16

(52) U.S. Cl. 277/500

(57) ABSTRACT

The invention relates to dynamical sealing systems for rotating pairs and can be used, in particular, for sealing of the bearing supports of cutter drill bits. The sealing (packing) ring has the cross-sectional cut of four-cornered shape, formed with the outer and inner cylindrical surfaces, including the side (end) surfaces, which define the ring height. The sufficient improvement of the efficiency and the service life of the sealing system are ensured, due to closed (dead-end) feed and drain lubricant grooves being provided on the working, sealing surface, and their inlet and outlet openings are positioned on the ring opposite surfaces bordering on the working surface. The outer, inner or end surface of the ring can serve as the working, sealing surface.

### CROSS-REFERENCE TO RELATED APPLICATIONS

This application is a U.S. national stage application of a PCT application PCT/UA2010/000091 filed on 13 Dec. 2010, published as WO/2011/078833, whose disclosure is incorporated herein in its entirety by reference, which PCT application claims priority of a Ukrainian application UA a2009 13521 filed on 25 Dec. 2009.

### FIELD OF THE INVENTION

The invention relates to sealing systems of the bearing units of machines and mechanisms. It can be used in particular for sealing of the bearing supports employed in cutter drill bits.

### BACKGROUND OF THE INVENTION

There is known a sealing (packing) ring employed in cutter drill bits, which made of rubber-based elastic material, wherein the ring cross-section is an oval, and the ring radial sizes exceed the axial sizes (U.S. Pat. No 3,765,495 dated Oct. 16, 1973, MΠK⁴ E21B9/10; F16C33/78).

The disadvantage of the known sealing ring lies in that the pressing force of the working surfaces is maximum in the middle part of the ring contact zone between the sealing ring and the leg, exactly in the place where the oval ring profile has the maximum deformation, resulting in lubricant being displaced outwards from the middle part of the ring contact zone. That's exactly the reason why the contact surfaces of the ring and the leg are operating under dry friction conditions, and therefore the ring is destroyed.

Another known sealing (packing) ring of the cutter drill bit, which is considered to be a related art device, has cylindrical and end surfaces that include concave (radiused) recesses for lubricant. The collars of the recesses are bounded by rounded sealing bands (U.S. Pat. No. 7,036,613 B2 issued May 2, 2006, MΠK7 E21B10/25).

The disadvantage of the aforesaid related art sealing (packing) ring is that its sealing bands certainly displace lubricant away from the contact zone of the ring and the leg, like it happens with any other sealing assembly having an oval sealing surface and uneven pressing force of the working surfaces. Even with a sufficient amount of lubricant in the recess, it completely disappears from the contact zone “ring-leg” a few minutes later after the start of operation of the sealing assembly, which is mounted, for example, in the cavity of the drill bit cutter. Therefore the contact surfaces are operating under dry friction conditions, the sealing bands are overheating, the elasticity level is lowering and the leak-proof requirements to the bearing supports of drill bit cutters are not met.

The closest related art device, herein called a prototype, is considered to be a textured sealing ring (seal packer), the central part of the inner surface of which is ribbed and forms a channel for lubricant (U.S. Pat. No. 4,691,534 issued Oct. 28, 1986, MΠK6 F16C33/78, E21B9/10) that is limited by cylindrical sealing bands from both sides.

The weak point of the prototype sealing (packing) ring is that the design of this packing ring doesn't ensure an effective lubrication of the contact surfaces of the rotating pair “the leg and working surfaces of the ring bands”, even when there is enough lubricant in the cavity of the ribbed channel. After several hundred rotations of the drill bit cutters the mentioned bands completely displace the lubricant outside the contact surfaces of these bands, and therefore the pair “seal packer-leg” start to operate under dry friction conditions. The seal packer material is overheating and resinification of the working surfaces of the bands occurs, they are splitting and the leak-proofing of the bearing supports of drill bit cutters is not ensured.

### AIM AND BRIEF SUMMARY OF THE INVENTION

It is the aim of the present invention to sufficiently improve the efficiency and the service life of the sealing (packing) ring.

This aim is achieved by designing a sealing (packing) ring (herein also called an ‘inventive ring’), which has a cross-sectional perimeter; the inventive ring is formed with outer cylindrical surfaces cylindrical surfaces, inner cylindrical surfaces, and two side (end) surfaces, wherein the cross-sectional perimeter is limited by the aforementioned surfaces, and the distance between the side surfaces defines a height of the ring height, herein also called a ‘ring height’. The inner surface constitutes a first possible option of a work surface of the inventive ring. The inventive ring comprises a plurality of closed (dead-end) lubricant feed grooves (further called ‘feed grooves’) and a plurality of closed (dead-end) lubricant drain grooves (further called ‘drain grooves’) arranged on the inner surface. The feed and drain grooves have respective longitudinal axis. The drain grooves each includes an inlet and outlet opening positioned on the opposite surfaces bordering on the inner surface.

The length of the lubricant grooves is greater than a half of the ring height, and the longitudinal axes of the feed grooves form acute angles together with the side ring surface, wherein the vertex of each acute angle is oriented towards the direction of rotation of the inner surface, which is responsive to the ring. The longitudinal axes of the drain grooves are directed anti-parallel to the axes of the feed grooves.

A second possible option of the work surface is represented by the outer cylindrical surface of the ring, which is provided with lubricant grooves.

A third possible option of the work surface is represented by the side (end) surface of the ring, wherein the inlet openings of the feed lubricant grooves are open at the inner cylindrical surface of the ring, and the outlet openings of the drain lubricant grooves are open at the outer cylindrical surface of the ring, while the length of the lubricant grooves is greater than a half of the height of the ring side surface, the longitudinal axes of the grooves cut the corresponding cylindrical surfaces at crossing points forming acute angles together with the tangent lines drawn through these points.

The side collars of the lubricant grooves are beveled. The longitudinal axes of the lubricant grooves are arc-shaped.

In comparison to the known related art devices and the prototype, such design of the sealing (packing) ring offers the following advantages:

there is an assured constant, even, and effective lubrication of the work surfaces of the rotation pair: the sealing ring and the sealing shaft, and the lubrication is maintained during the whole service life of the drill bit bearing support or any other bearing assembly;

the possibility of overheating of the support bearings due to dry frictions between the contact surfaces of “ring-leg” is completely eliminated, as the lubrication system of a modern cutter drill bit is so rich in lubricant that, if the reliable leak-proofing of the supports is assured, the amount of lubricant will be more than enough to provide the effective lubrication of the bearing supports of the sealing pair contact zones during the entire operating life of the drill bit;

the design of the inventive sealing (packing) ring is broad-based: depending on a variant of the embodiment of the bearing support, it can ensure the positive sealing of both radial and side work surfaces of the bearing supports;

besides, the inventive ring can work as a seal packer, i.e. to serve as a sealing assembly that is capable of confining the lubricant in the sealing zone and spread the lubricant evenly and thinly throughout the full height of the ring and the leg contact zones or the contact zones of the ring and the cutter end.

the design of the sealing (packing) ring additionally helps the permanent, protective, self-replenishing oil seal coat to keep on forming on the outer side of the sealing ring, which eliminates the possibility of bit cuttings or drilling mud to negatively impact on the work surfaces in the sealing zone.

### BRIEF DESCRIPTION OF DRAWINGS

The invention may be fully understood by reference to the accompanying drawings, where:

FIGS. 1, 2 are front sectional plane views of the radial sealing (packing) ring with the inner working surface;

FIGS. 3, 4 are front sectional plane views of the radial sealing (packing) ring with the outer working surface;

FIG. 5 is a cross-sectional view of the lubricant groove of the sealing (packing) ring, taken from the direction indicated by arrow A shown in FIG. 2;

FIG. 6 is the view of the lubricant groove taken from the direction indicated by arrow B shown in FIG. 5;

FIG. 7 is the front sectional plane view of the end sealing (packing) ring;

FIGS. 8, 9 are the alternative embodiments of the lubricant grooves of the sealing (packing) end ring, view C;

FIG. 10 is a variant of the “leg-ring” sealing provided in the cutter drill bit bearing support;

FIG. 11 is another variant of “ring-cutter” sealing provided in the cutter drill bit bearing support;

FIG. 12 is a variant of the “end ring-leg front edge” sealing of the cutter drill bit; and

FIG. 13 is a cross-sectional view of the drill bit leg taken by D-D.

### PREFERRED EMBODIMENTS OF THE PRESENT INVENTION

While the invention may be susceptible to embodiment in different forms, there are described in detail herein below, specific embodiments of the present invention, with the understanding that the present disclosure is to be considered an exemplification of the principles of the invention, and is not intended to limit the invention to that as illustrated and described herein.

The sealing (packing) ring offers three main, basic variants of manufacture and embodiment as follows.

Variant 1 is the radial sealing (packing) ring with the inner sealing work surface aimed at sealing the bearing supports of the cutters and shafts of any mechanisms in accordance with the “ring-leg (shaft)” configuration.

Variant 2 is the radial sealing (packing) ring with the outer sealing work surface aimed at sealing throughout the inner cylindrical surface of the cutter in accordance with the “ring-cutter” configuration.

Variant 3 is the end sealing (packing) ring aimed at sealing flat, movable contact surfaces of the parts that are rotatably connected in accordance with the “ring end-seal end” configuration.

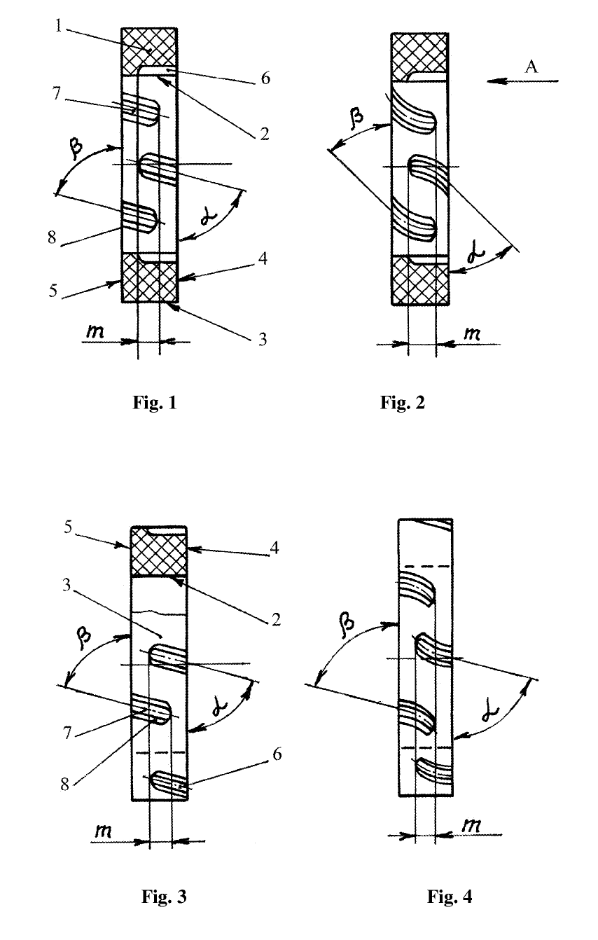

The radial sealing (packing) ring in accordance with Variant 1 (FIGS. 1, 2) is made of elastic material, e.g. a rubber-based polymer. The cross sectional cut of the ring has the shape of, for example, a quadrilateral 1, whose perimeter is formed with an inner work sealing cylindrical surface 2, an outer cylindrical surface 3 and side (end) surfaces 4 and 5.

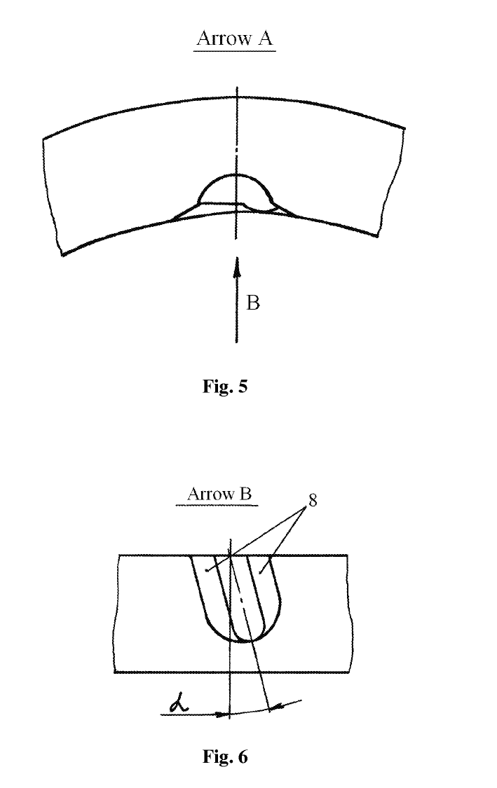

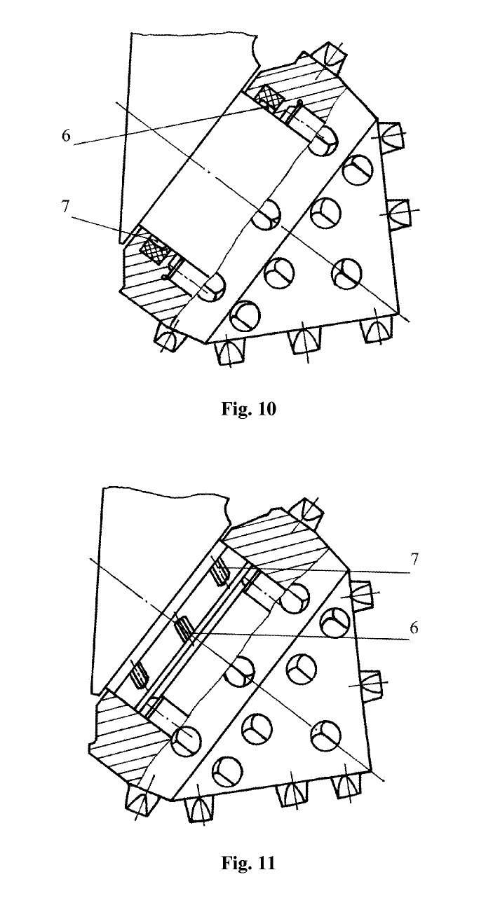

The inner cylindrical surface 2 is employed with closed (dead-end) lubricant (oil) grooves: feed grooves 6 and drain grooves 7, each having a longitudinal axis. The longitudinal axes of the grooves can be implemented in the shape of multifilar helix segments (FIG. 1) or in the shape of crescent segments (FIG. 2). The length of the lubricant grooves 6 and 7 is greater than the half of the ring height. The side collars of the lubricant grooves 6, 7 have bevels 8 (FIGS. 5, 6) with flat or convex surfaces. The longitudinal axes of the feed grooves 6 form acute (less than 90°) angles α with the plane of side surface 4, and the vertices of angles α are oriented towards the direction of rotation responsive to the ring of the sealing leg, shaft, etc. The longitudinal axes of the drain grooves 7 are directed anti-parallel to the longitudinal axes of the feed grooves 6 or to the ring side surface 5 at an acute angle β. The vertices of angles β are oriented at the opposite direction with respect to the angles α. The dead-end sections of the feed grooves 6 and drain 7 grooves are located in the middle part of the work surface 2 in such a way that they form a common interaction region, having a width of a value m. This value is being defined during the designing of the ring and it depends on an assumed frequency of the ring rotation (the value of angular velocity of rotation), a selected polymer type, and a lubricant viscosity level in the bearing support. One of possible alternatives of the sealing ring arrangement in the cutter drill bit bearing support is shown on FIG. 10.

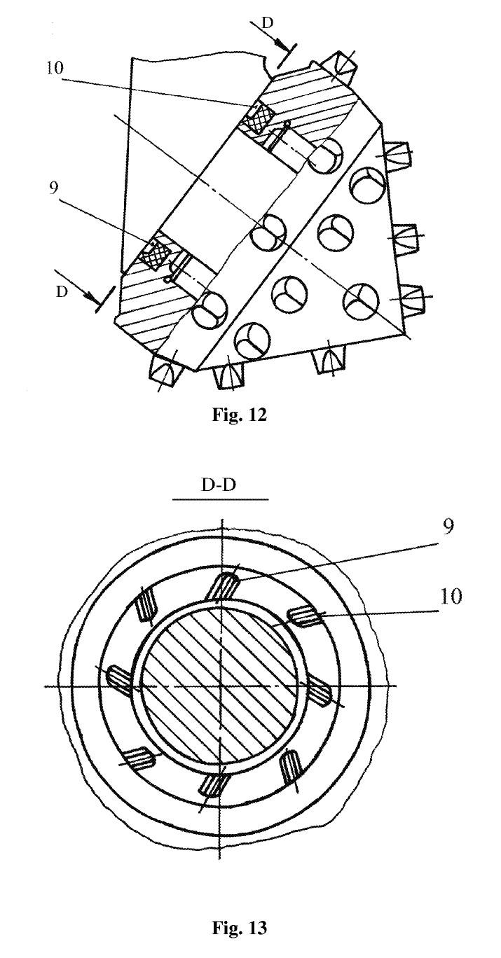

The radial sealing (packing) ring in accordance with Variant 2 (FIGS. 3, 4) is made of rubber-based polymer. The cross sectional cut of the ring has mainly the shape of quadrilateral 1, whose perimeter is formed with the inner cylindrical surface 2, the outer work sealing cylindrical surface 3, and side surfaces 4, 5. The outer cylindrical surface 3 is employed with the dead-end lubricant grooves: feed grooves 6 and drain grooves 7, each having a longitudinal axis. The length of the lubricant grooves is greater than a half of the ring height. The side collars of the lubricant grooves have convex or flat bevels 8 (FIGS. 5, 6). The longitudinal axes of the lubricant grooves can be implemented in the shape of multifilar helix segments (FIG. 3) or in the shape of crescent segments (FIG. 4). The longitudinal axes of the feed grooves 6 form acute angles α with the plane of side surface 4, and the vertices of these angles are oriented towards the direction of rotation of the ring of the sealing inner surface of the cutter cavity, cylinder, etc. The longitudinal axes of the drain grooves 7 form acute angles β with the side surface 5 of the ring, and the vertices of these angles are directed anti-parallel to the angles α. The dead-end sections of the feed and drain lubricant grooves form a common interaction region in the middle part of the work surface 3. The width of this zone has a value m. One of possible alternatives of the sealing ring arrangement in the cavity of the cutter drill bit bearing support is shown on FIG. 11.

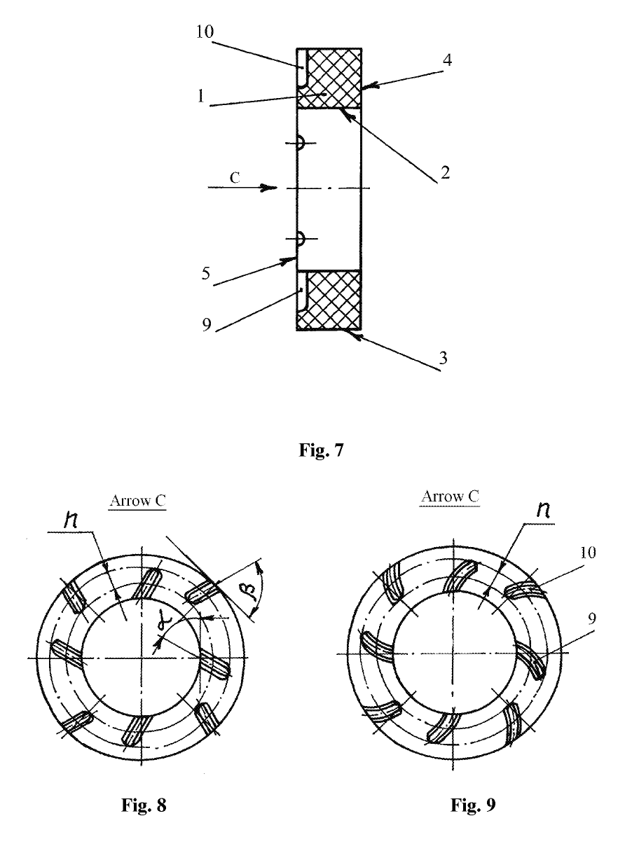

The end sealing (packing) ring in accordance with Variant 3 (FIGS. 7, 8, 9) is made of rubber-based polymer. The cross sectional cut of the ring has a shape of quadrilateral 1, whose perimeter is formed with an inner cylindrical surface 2, an outer cylindrical surface 3, a side surface 4, and a side work surface 5. The side surface 5 is employed with the dead-end lubricant grooves: feed grooves 9 and drain grooves 10, each having a longitudinal axis. The side collars of the grooves 9, 10 have flat or convex bevels 8. The longitudinal axes of the lubricant grooves can be implemented as straight lines or in the view of short arcs (FIGS. 8, 9). The length of the lubricant grooves is greater than a half of the height of the side work surface 5. The inlet openings of the feed lubricant grooves are open at the inner cylindrical surface 2, and the outlet openings of the drain lubricant grooves are open at the outer cylindrical surface 3. The longitudinal axes of the lubricant grooves cut the cylindrical surfaces 2 and 3 in such a way that at the crossing points they form acute angles together with the tangent lines drawn through these points. The vertices of acute angles formed by axes of the feed grooves and the tangent lines are oriented towards the direction of rotation of the support sealing surface, which corresponds to the work surface. The dead-end parts (sections) of the feed 9 and drain 10 lubricant grooves are located in a circle on the side surface 5, overlapping a common area of the ring, whose height has a value n. One of possible alternatives of the end sealing ring arrangement, for example, in a cutter drill bit bearing support is shown on FIGS. 12 and 13.

The sealing (packing) ring with the inner cylindrical work surface (FIGS. 1, 2, and 10) operates in the following way. The inventive sealing ring is covered with a thin coating of special (for drill bits) lubricant and placed into the ring groove purposely made in the cavity of the cutter. The cutters together with the bearing elements and sealing rings are mounted on the drill bit legs. The drill bit is connected to a drilling machine rod to be then brought to the downhole. The cutters of the drill bit come into a mechanical contact with the rock and roll over the downhole, destroying a certain layer of the rock surface. Each cutter rotates around the axis of its leg.

While the cutters are rotating, the lubricant disposed on the contact work surfaces of the ring and the leg forms a stationary oil film of a certain thickness. This film not only reduces frictions between the adjoined surfaces, but also improves the sealing capacity. The surplus lubricant gathered in the adjoined zone due to elastic properties of the ring is displaced outside of the borders of the ring work surfaces and partially moved to the cavities of the lubricant grooves.

The lubricant accumulated in the cavities of the feed lubricant grooves 6 is being little by little brought to the adjoined zone of “ring-leg” by means of the bevels 8. This lubricant forms an oil film, the width of which corresponds to the length of the feed grooves 6. Since the length of the feed and drain grooves is greater than a half of the ring height, the work zones of the feed and drain grooves reciprocally overlap by a specific value m. This value is predetermined during the designing of the ring and it depends on the assumed frequency of the ring rotation, the selected ring material type and lubricant viscosity level.

Some amount of the lubricant from the oil film gathered in the zone m is displaced to the dead-end zones of the drain grooves 7, filling them out little by little. Due to the axes of the lubricant grooves being inclined at an acute angle to the ring rotation axis, the lubricant accumulated in the cavities of the feed and drain grooves is gradually moving in the direction of the side surface 5 of the ring. Because of the bevels 8 being located on the collars of the lubricant grooves 7, some lubricant travels from the cavity of these grooves into the work adjoined zone of “ring-leg”. This portion of the lubricant forms a permanent oil film in the work zones starting from the bottom of the feed grooves 6 up to the side surface 5 of the ring.

As far as the cavities of the grooves 7 are being filled with lubricant, a certain portion thereof moves to the outer side surface 5 of the ring through the outlet openings of the drain grooves. Therefore the outer side of the sealing pair is employed with the self- replenishing protective oil seal coating (oil ring), which prevents bit cuttings or drilling mud to fall into the sealing zone. In the cavities of the feed grooves the current lubricant flow is continuously replenishing due to the lubricant located in the cavities of the bearing supports and in of the drill bit lubrication system. The lubricant is forcibly fed into the operational zone of the inlet openings of the feed grooves 6 due to centripetal force.

The radial sealing (packing) ring with the outer cylindrical work surface (FIGS. 3, 4, and 11) operates in the following way. The sealing ring is covered with a thin coating of lubricant and placed into a special ring groove made on the leg's neck close to its base. The cutters together with the bearing elements are mounted on the drill bit legs in accordance with the generally accepted technology. The drill bit is connected to the drilling machine rod to be then brought to the downhole. The cutters of the drill bit come into a mechanical contact with the rock and roll over the downhole, destroying a certain layer of the rock surface. Each cutter is rotating around the axis of its leg and around the axis of the downhole. As far as the cutters start rotating, the lubricant disposed on the contact surfaces of the ring and of the cutter forms a stationary oil film of certain thickness in the connection zone. The surplus lubricant is displaced into the cavities of the grooves and partially outside of the borders of the ring. The bevels 8 of the lubricant grooves and the contact work surface of the cutter cavity form together a wedge-like clearance, by means of which the lubricant is gradually getting into the sealing contact zone oil film. A certain portion of the lubricant from the oil film in the zone m, which is simultaneously overlapped with dead-end parts of the feed and drain grooves, moves into the cavities of grooves 7. Due to the longitudinal axes of the lubricant grooves being inclined to the axis of the ring rotation, the lubricant accumulated in the cavities of the feed and drain grooves is gradually moving in the direction from the side surface 4 to the side surface 5 of the ring. Because of the bevels 8 located on the collars of grooves 7, some lubricant is displaced into the work adjoined zone of “ring-cutter”, while the surplus lubricant goes to the outside through the outlet openings of the grooves 7. This surplus forms a ring-shaped, self-replenishing protective oil seal coating close to the side surface 5 of the ring. The coating prevents drilling mud to fall into the sealing zone. In the feed grooves and in the bearing support cavity the current lubricant flow is continuously replenishing due to the lubricant located in special leak-proof cavities of the drill bit lubrication system. From the bearing support cavity to the zone of the inlet openings of the feed grooves 6, the lubricant is forcibly fed due to centripetal force.

The end sealing (packing) ring (FIGS. 7, 12, and 13) operates in the following way. The sealing ring (FIGS. 7, 8, 9) is covered with a thin coating of lubricant and placed into a special ring groove made on the side surface of the cutter base disposed concentrically with respect to its rotation axis. The cutters together with the sealing end rings, bearing elements, and lubricant are mounted on the drill bit legs in accordance with the generally accepted technology. The work surface 5 of the ring should fit tightly, but with elastic deformation against the sealing end of the drill bit leg concentrically with respect to the corresponding leg axis. The drill bit is connected to the drilling machine rod to be then brought to the downhole. As far as the cutters start rotating, the lubricant found on the contact surfaces of the ring and the sealing leg end forms an oil film of a certain thickness in the connection zone. The oil film ensures the minimal friction in the connection zone and sufficiently improves the leak-proofing of the dynamically rotatable sealing. Due to centripetal force, the portion of the lubricant located in the bearing support cavity of each cutter is gradually moving in the direction of the leg base, wherein it falls into the inlet openings of the feed grooves 9, filling out their cavities. Because of the rotation of the cutters, the lubricant from the feed groove cavities is absorbed in wedge-like clearances, formed with the bevels 8 of the lubricant grooves and sealing end. A certain portion of the lubricant from the oil film falls into the cavities of the drain grooves 10, gradually filling them out. Another portion of the lubricant is once again absorbed in the wedge-like clearance located between the zone n and the outer cylindrical surface 3 of the ring. The surplus lubricant is being gradually displaced through the outlet openings of the drain grooves 10 to the outside, wherein it forms a ring-shaped oil seal coating. This self-replenishing seal coating protects the joint of the contact surfaces of the sealing connection from the negative impact of drilling mud.

The trial samples of the sealing (packing) rings have been manufactured and then successfully tested.

1. A sealing ring comprising an outer cylindrical surface; an inner cylindrical surface, side surfaces defining a height of said ring therebetween,; said ring having a perimeter formed with said outer, inner, and side surfaces; a plurality of feed lubricant grooves each having an open inlet and a closed outlet; a plurality of drain lubricant grooves each having a closed inlet and an open outlet; wherein
said open inlets and said open outlets are positioned on the opposite surfaces bordering on the outer surface.

2. The sealing ring according to claim 1, wherein said lubricant grooves each has a longitudinal axis having a predetermined length; said sealing rings is characterized in that the work surface is represented by the inner cylindrical surface, wherein said length of the lubricant grooves is greater than a half of said height, and said longitudinal axes of the feed lubricant grooves form acute angles together with the side surface, wherein the vertex of each said acute angle is oriented towards the direction of rotation and the longitudinal axes of the drain lubricant grooves are directed anti-parallel to the axes of said feed grooves.

3. The sealing ring according to claim 1, characterized in that the work surface is represented by the outer cylindrical surface.

4. The sealing ring according to claim 1, characterized in that the work surface is represented by the side surface,
where the inlet openings of the feed lubricant grooves are open at the inner cylindrical surface of the ring, and the outlet openings of the drain lubricant grooves are open at the outer cylindrical surface of the ring, while the length of the lubricant grooves is greater than the half of the width of the ring side surface, and the longitudinal axes of the grooves cut the adjoining cylindrical surfaces, at crossing points forming acute angles together with the tangent lines drawn through these points.

5. The sealing ring according to claim 1, characterized in that the lubricant grooves have beveled side collars.

6. The sealing ring according to claim 1, characterized in that the longitudinal axes of the lubricant grooves are arc-shaped.
